(19) United States
(12) Patent Application Publication
(10) Pub. No.: US 2010/0047756 A1
(43) Pub. Date: Feb. 25, 2010

(54) SYSTEMS AND METHODS FOR TRAINING SECURITY OFFICERS

(75) Inventors: Charles R. Schneider, Alpharetta, GA (US); James P. Boylan, JR., Brunswick, OH (US)

Correspondence Address: SUTHERLAND ASBILL & BRENNAN LLP, 999 PEACHTREE STREET, N.E., ATLANTA, GA, 30309, US

(73) Assignee: U.S. SECURITY ASSOCIATES, INC., Roswell, GA (US)

(21) Appl. No.: 12/547,308

(22) Filed: Aug. 25, 2009

Related U.S. Application Data
(60) Provisional application No. 61/091,538, filed on Aug. 25, 2008.

(51) Int. Cl. G09B 7/00

(52) U.S. Cl. 434/350; 434/322; 434/362

(57) ABSTRACT

Systems and methods for training security officers are disclosed. A telecommunications node situated at a guard location may be operable to facilitate the presentation of training questions to a guard situated at the guard location. A training module may be operable to determine one or more training questions to communicate to the telecommunications node based at least in part on a predetermined condition. The training module may further be operable to communicate the one or more training questions to the telecommunications node via a network and to receive a respective answer to each of the one or more training questions from the telecommunications node. The training module may further be operable to determine whether the received answers are correct.

### CROSS-REFERENCE TO RELATED APPLICATION

The present application claims the benefit of U.S. Provisional Application No. 61/091,538, filed Aug. 25, 2008, and entitled “Systems and Methods for Training Security Officers,” the disclosure of which is incorporated by reference herein in its entirety.

### FIELD OF THE INVENTION

Embodiments of the invention relate generally to security officer training, and more particularly, to systems and methods for training security officers on an ongoing basis.

### BACKGROUND OF THE INVENTION

It is well known and quite common for commercial and industrial premises to be protected by security companies providing on-site security guards as a service. A security company typically employs and trains guards, which are assigned to patrol the premises of customers of the security company. To ensure that the premises are protected, each guard is responsible for thoroughly and regularly patrolling all or part of the premises. The security company will typically specify a “tour” that must be completed by a particular guard at predetermined intervals. A tour typically consists of a number of checkpoints located along a predefined route. While completing a tour, a guard inspects the customer's property, checking security conditions and looking for intruders or other unauthorized activity. In addition, guards take note of situations that tangentially affect security, including maintenance problems such as lighting fixture failures. To verify completion of each tour, a guard may be required to record the status of the premises at each checkpoint.

Guards that are employed by a security company typically complete a training program prior to being assigned to a customer location. Once a guard is assigned to a customer location, the guard may receive an initial orientation at the location. However, following the initial orientation, the guard may not receive any additional ongoing training. Customers of the security company often express concerns that the guards are not trained after their initial orientation. This lack of training may lead to a degradation in guard performance over time.

Accordingly, there is a need for improved systems and methods for training security officers or guards.

Additionally, various methods and systems exist in the prior art for verifying the completion of a tour. One such method requires the guard performing a tour to manually complete a tour log book, which is subsequently submitted to either the security company or a client of the security company. However, if a portion of the tour was not completed, or a non-emergency situation was logged, the security company and/or the client would not be notified in a timely matter. For instance, if a theft went undetected during a guard's shift, the security company and/or the client would have to review the log to determine whether the guard failed to detect the theft because one or more checkpoints were omitted from the guard's tour. Additionally, a guard may be tempted to fabricate or alter entries in a manual tour log book.

Another method for verifying completion of a tour is a Detex Clock. A Detex Clock is a device that contains a removable card that is marked at each location on a guard's tour by a key. A different card is used for each tour completed with the Detex Clock. Accordingly, the Detex clock allows a security company to later verify that a tour was completed in a timely matter by reading the marks on the removable card. These cards, however, are difficult to read and, like the tour log book, do not notify the security company of uncompleted tours or non-emergency situations in a timely matter.

Electronic tour tracking systems are also used to verify the completion of a guard tour. Prior art electronic tour tracking systems typically include a wand that a guard touches to a fixed button at each checkpoint along the tour. The record of the tour is stored in the wand until the guard uses a docking station to upload the data to a centralized monitoring system operated by the security company. The upload is typically completed at the end of the guard's tour. While the current electronic tour tracking systems may make it easier for security company's to process tour information, they still do not provide immediate notification to the security company of uncompleted tours or non-emergency situations.

### BRIEF DESCRIPTION OF THE INVENTION

Some or all of the above needs and/or problems may be addressed by certain embodiments of the invention. Embodiments of the invention may include systems and methods for training security officers or guards. According to one embodiment of the invention, there is disclosed a guard training system. The guard training system may include a telecommunications node situated at a guard location and a training module. The telecommunications may be operable to facilitate the presentation of training questions to a guard situated at the guard location. The training module may be operable to determine one or more training questions to communicate to the telecommunications node based at least in part on a predetermined condition. The training module may further be operable to communicate the one or more training questions to the telecommunications node via a network and to receive a respective answer to each of the one or more training questions from the telecommunications node. The training module may further be operable to determine whether the received answers are correct.

According to another embodiment of the invention, there is disclosed a method for training a security guard. One or more training questions for presentation to a guard may be determined based at least in part on identifying a predetermined condition. The one or more training questions may be communicated to a telecommunications node situated at a guard location for presentation to the guard, and a respective answer to each of the one or more training questions may be received from the telecommunications node. A determination may then be made as to whether the received answers are correct.

According to yet another embodiment of the invention, there is disclosed a guard training system. The guard training system may include a communicator and a training module. The communicator may be operable to collect data associated with one or more tour points of a guard tour and further operable to display training questions to a guard utilizing the communicator. The training module may be operable to determine one or more training questions to communicate to the guard based at least in part on a predetermined condition and to communicate the one or more training questions to the communicator via a network. The training module may further be operable to receive a respective answer to each of the one or more training questions from the communicator and to determine whether the received answers are correct.

Additional systems, methods, apparatus, features, and aspects are realized through the techniques of various embodiments of the invention. Other embodiments and aspects of the invention are described in detail herein and are considered a part of the claimed invention. Other embodiments and aspects can be understood with reference to the description and the drawings.

### BRIEF DESCRIPTION OF THE DRAWINGS

Having thus described the invention in general terms, reference will now be made to the accompanying drawings, which are not necessarily drawn to scale, and wherein:

FIG. 1 is a schematic diagram of one example guard tour system, according to an illustrative embodiment of the invention

FIG. 2 is a block diagram of one example communicator that may be utilized in accordance with a guard tour system, according to an illustrative embodiment of the invention.

FIG. 3 is a schematic diagram of one example guard tour that may be conducted utilizing a guard tour system, according to an illustrative embodiment of the invention.

FIG. 4 is a flowchart depicting one example method of the operation of a communicator utilized in conjunction with a guard tour system, according to an illustrative embodiment of the invention.

FIG. 5 is a flowchart depicting one example method of the operation of a monitoring system utilized in conjunction with a guard tour system, according to an illustrative embodiment of the invention.

FIG. 6A is a one example graphical user interface depicting data collected during a guard tour, according to an illustrative embodiment of the invention.

FIG. 6B is another example graphical user interface depicting data collected during a guard tour, according to an illustrative embodiment of the invention.

FIG. 7 is a schematic diagram depicting one example inspection point for a guard tour, according to an illustrative embodiment of the invention.

FIG. 8 is a flowchart depicting one example method for providing regular training to a guard, according to an illustrative embodiment of the invention.

FIG. 9 is an example report that may be generated from collected guard training data, according to an illustrative embodiment of the invention.

### DETAILED DESCRIPTION OF THE INVENTION

Embodiments of the invention now will be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

As used herein, the term “communicator” refers to any suitable or appropriate device that facilitates the electronic collection of data associated with a guard tour and/or with guard training as described herein.

Disclosed are systems and methods for providing regular training to one or more guards that are assigned to provide security to a client site, such as, a commercial or industrial site. A guard may utilize a communicator or other suitable data collection device during the performance of his/her duties. The communicator may be utilized to collect information associated with the guard, associated with the client site, and/or to associated with one or more guard tours conducted by the guard. The gathered data may be communicated or transmitted by the communicator to a data collection and monitoring center. The gathered data may be communicated to the data collection and monitoring center in real time, near real time, or close to real time following its collection. For example, information associated with the guard, such as guard login and/or logout information for the communicator, may be communicated to the data collection and monitoring center in real time or near real time following its collection. As another example, gathered data associated with a guard tour may be communicated to the data collection and monitoring center in real time or near real time, which may include communicating the data prior to the completion of the guard tour. The data collection and monitoring center may analyze received data associated with a guard tour in order to identify exceptions. If an exception is identified, the data collection and monitoring center may communicate information and/or instructions associated with the identified exception to the guard, the guard's supervisor, a manager of the data collection and monitoring center, a maintenance supervisor, a client and/or another individual(s) or entity associated with the guard tour. Additionally, the data collection and monitoring center may be associated with a training module that facilitates regular training of a guard. When a guard is on duty at the client site, the training module and/or the data collection and monitoring center may communicate training programs, training applications, and/or training questions to the guard. Answers to communicated training questions may be received and analyzed.

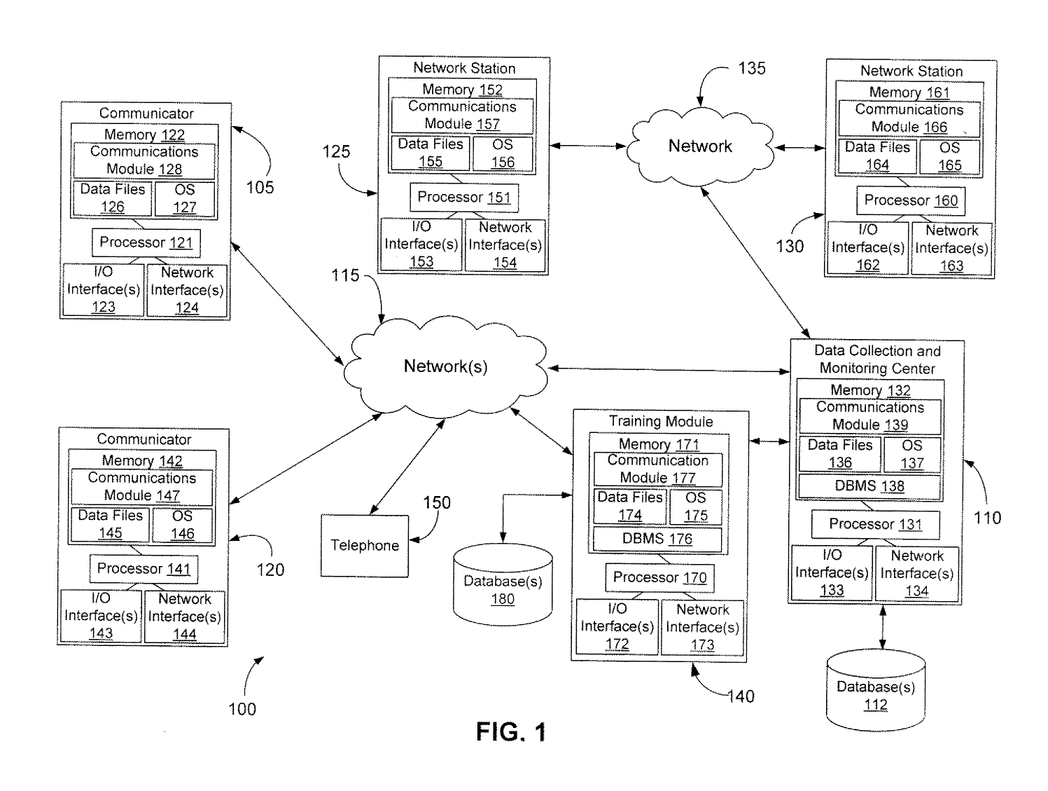

FIG. 1 is a schematic diagram of one example guard tour system 100, according to an illustrative embodiment of the invention. The guard tour system 100 may include a communicator 105, a data collection and monitoring center 110, and a training module 140. The communicator 105 may be utilized to collect data while a guard is on duty at a client site. For example, the communicator 105 may be utilized to collect login and logout information from the guard while the guard is on duty. As another example, the communicator 105 may be utilized to collect data during the course of a guard tour. Once data is collected by the communicator 105, the data may be transmitted or otherwise communicated to the data collection and monitoring center 110 via one or more suitable networks 115. The data may be transmitted to the data collection and monitoring center 110 in real time or near real time as the data is collected. For example, login and logout information for the guard may be communicated to the data collection and monitoring center 100 in real time or at a time that is proximately close to the time at which the data was collected. As another example, data collected at each point on a guard tour may be transmitted to the data collection and monitoring center 110 in real time or at a time that is proximately close to the time at which the data was collected. Alternatively, the communicator 105 may store collected data and communicate the stored data to the data collection and monitoring center 110 at a subsequent point in time. For example, data may be communicated to the data collection and monitoring center 110 after a guard tour is completed by the guard or at set intervals during a guard tour (e.g., at every other point on the tour). As another example, data may be communicated to the data collection and monitoring center 110 at predetermined time intervals, for example, every minute or every five minutes.

The communicator 105 may be any processor-driven device, such as a handheld computer, minicomputer, programmable device, mobile device, and the like. In addition to having a processor 121, the communicator 105 may further include a memory 122, input/output (“I/O”) interface(s) 123, and one or more network interfaces 124. The memory 122 may store data files 126 and various program modules, such as an operating system (“OS”) 127 and a communications module 128. The communications module 128 may be a software program operable to manage interactions and/or communications with the data collection and monitoring center 110 and/or with the training module 140. For example, a guard or other user may utilize the communicator 105 to input login information, logout information, identification information, and/or information associated with a guard tour, and the communications module 128 may facilitate the communication of at least a portion of the inputted data to the data collection and monitoring center 110.

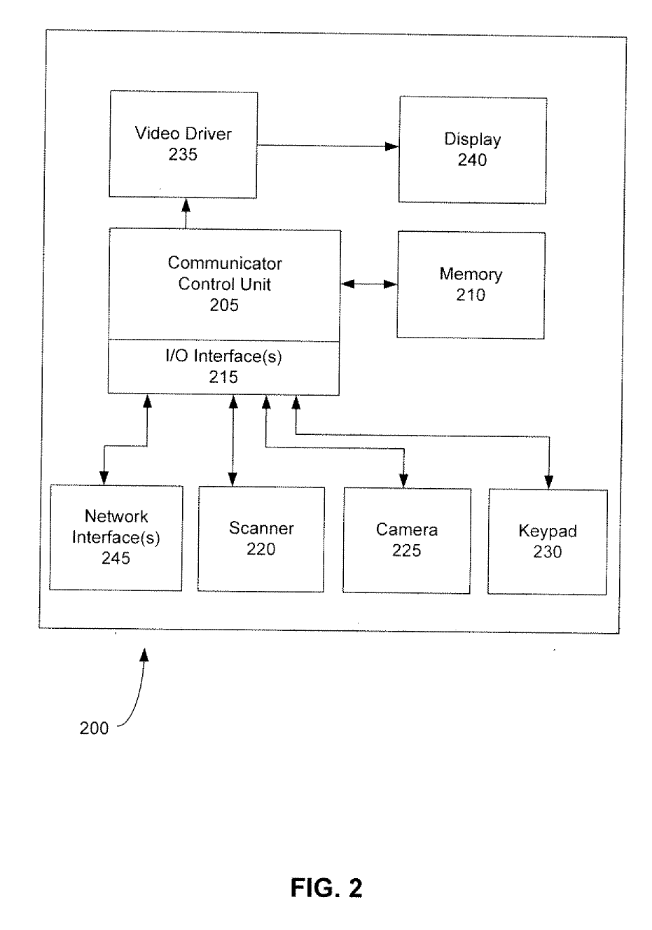

Still referring to the communicator 105, the I/O interface(s) 123 may facilitate communication between the processor 121 and various I/O devices associated with the communicator 105, such as a keypad, touch screen, camera, scanner, RFID reader, and the like. The network interface(s) 124 may take any of a number of forms, such as a network interface card, a modem, a wireless network card, a cellular network card, and the like. One example of a communicator that may be utilized is described in greater detail below with reference to FIG. 2.

In certain embodiments of the invention, for example, in embodiments that do not include a guard communicator 105, a guard may utilize a telephone 150 to clock into and/or to clock out of work. The telephone 150 may also be utilized to log into and/or log out of an appropriate guard monitoring station, for example, a station that includes similar components to that of the data collection and monitoring center 110. A guard may use the telephone 150 to enter an identification number that is communicated to a guard monitoring station at the beginning and at the end of a guard's shift. In this regard, the guard's hours on the job may be monitored and/or tracked.

Additionally, in certain embodiments, the guard monitoring station may connect the telephone 150 and the guard to the training module 140 or, alternatively, the guard monitoring station may facilitate communication between the telephone 150 and the training module 140. For example, once the guard clocks in or clocks out, the guard may be connected to the training module 140, and the training module 140 may communicate one or more training questions to the guard. In other embodiments of the invention, the guard may utilize the telephone 150 to establish a direct communication link with the training module 140, for example, by calling the training module.

The one or more networks 115 may include any appropriate networks utilized to transmit data between the communicator 105, the data collection and monitoring center 110, and/or the training module 140. According to one embodiment of the invention, networks 115 may include a cellular network. According to other embodiments of the invention, the networks 115 may include a conventional telephone network or a public switched telephone network. However, other types of networks may be utilized as desired in various embodiments of the invention, such as, radio networks, wireless networks, and/or wide area networks (e.g., the Internet). Additionally, in certain embodiments, the network 115 may include multiple networks, for example, both a cellular network and a conventional telephone network.

The data collection and monitoring center 110 may be any processor-driven device or plurality of devices, such as a personal computer, laptop computer, handheld computer, server and the like, that is configured for receiving data from the communicator 105 and processing the received data. The processing station 110 may include a processor 131, a memory 132, input/output (“I/O”) interface(s) 133, and a network interface 134. The memory 132 may store data files 136 and various program modules, such as an operating system (“OS”) 137, a database management system (“DBMS”) 138, and a communications module 139. The communications module 139 may receive data from the communicator 105 and/or the telephone 150, and at least a portion of the received data may be processed for a wide variety of purposed. For example, at least a portion of the received data may be processed to identify guard tour exceptions from guard tours conducted utilizing the communicator. As another example, at least a portion of the received data may be processed in conjunction with ongoing training of the guard utilizing the communicator. Additionally, in certain embodiments of the invention, the processing station 110 may communicate with one or more data sources (not shown) via the network 115 in order to receive additional data that may be utilized in guard training and/or in processing guard tour data. Data received from the communicator 105 and/or from one or more data sources may be stored in one or more suitable memory devices associated with the communications module data collection and monitoring center 110, such as, database 112. One may appreciate that the processing station 110 may include alternate and/or additional components, hardware or software. For example, the processing station 110 may include one or more user interface device(s), for example, a keyboard, mouse, control panel, microphone, etc., that facilitate user interaction with the processing station 110.

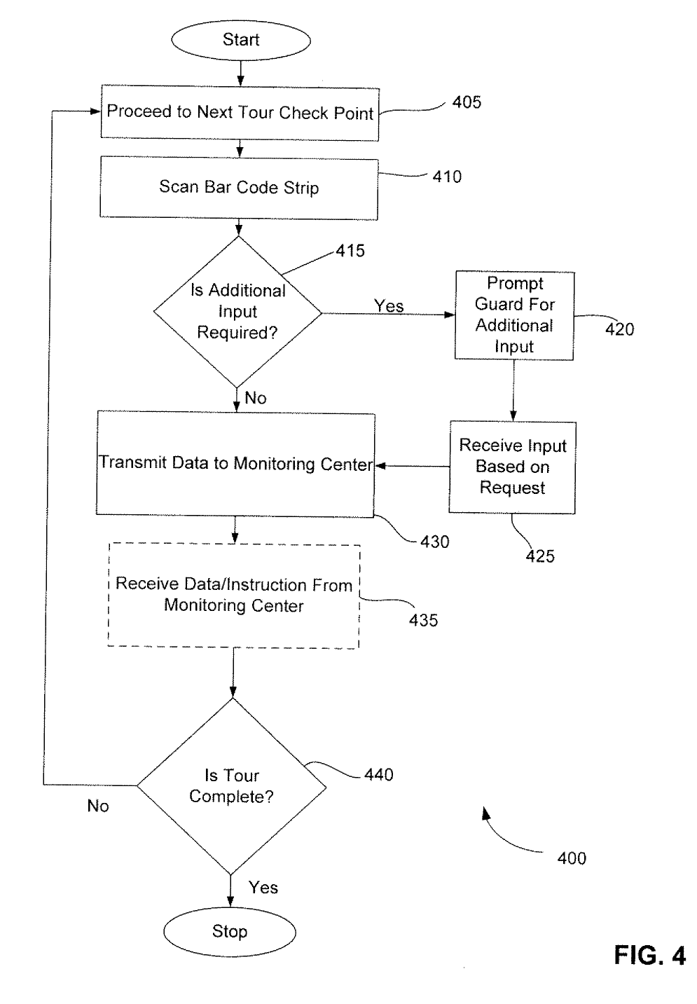

The data collection and monitoring center 110 may store data received from the communicator 105 in one or more suitable memory devices and/or associated data repositories, such as, one or more databases 112. The data received by the data collection and monitoring center 110 may include data associated with the communicator 105, data associated with the guard utilizing the communicator 105, and/or data associated with one or more points of a guard tour conducted utilizing the communicator. Data associated with the communicator 105 and/or the guard may include an identification number of the communicator 105, identification information for the guard that is utilizing the communicator 105 to conduct the tour (e.g., the name of the guard or an operating number of the guard), login information for the guard, logout information for the guard, and/or a current location of the communicator. In certain embodiments, the current location of the communicator may be a global positioning system (GPS) coordinate for the communicator 105. The data associated with one or more points of the guard tour may include information identifying a point on the guard tour, information associated with a time at which a tour point was visited or inspected by the guard, and inspection information associated with a guard point, as explained in greater detail below with reference to FIG. 4.

In certain embodiments of the invention, the data collection and monitoring center 110 may analyze at least a portion of the received data in order to determine whether ongoing training should be provided for the guard. A wide variety of triggers may be identified in a determination of whether ongoing training should be provided for the guard. For example, a determination to provide training may be made based on the receipt of login information, logout information, information associated with the commencement of a guard tour, information associated with the completion of a guard tour, information collected during the guard tour, etc. The ongoing training may be provided by the training module 140, which may be a component of the data collection and monitoring center 110 or a separate component of the guard tour system 100. The functionality of the training module 140 is discussed in greater detail below.

In certain embodiments of the invention, the data collection and monitoring center 110 may analyze received data associated with a guard tour in order to identify one or more exceptions that have occurred during the guard tour. Exceptions that may be identified by the data collection and monitoring center 110 include, for example, security exceptions, maintenance exceptions, and/or tour point exceptions. A security exception may be identified if the analysis of the received data indicates a situation in which a security breach has occurred, has likely occurred, or may occur. For example, a security exception may be identified if the received data indicates a situation in which a lock has been broken, a door or gate has been left unlocked, a door or gate has been damaged, a fence has been damaged, property has been taken, and/or intruders are located on the premises. In a typical situation, a security exception may be identified based on specific information identifying a potential security threat or breach that is transmitted by the communicator 105. For example, a guard may cause the communicator 105 to transmit an alarm signal to the data collection and monitoring center 110. The guard may alternatively or additionally cause the communicator 105 to transmit information other than an alarm signal that indicates a security threat or breach, such as, data input by the guard into the communicator 105 concerning the security threat or breach or a picture of the security threat or breach that is taken with a camera included in the communicator 105. Additionally, a guard may follow a standard procedure to identify a particular type of security exception. For example, the guard may utilize the communicator 105 to select a particular type of security exception that is to be transmitted to the data collection and monitoring center 110. As an example, the guard may select a particular type of security exception from a menu that is graphically displayed to the guard by the communicator 105. As another example, the guard may utilize the communicator 105 to scan a bar code associated with a particular type of security exception. The scanned bar code may be a bar code that is situated on a scan card that is carried by the guard during the guard tour. As another example, the guard may activate voice commands that are supported by the communicator 105. A wide variety of security exceptions may be identified by the data collection and monitoring center 110 as desired in various embodiments of the invention based at least in part on the data received from the communicator 105.

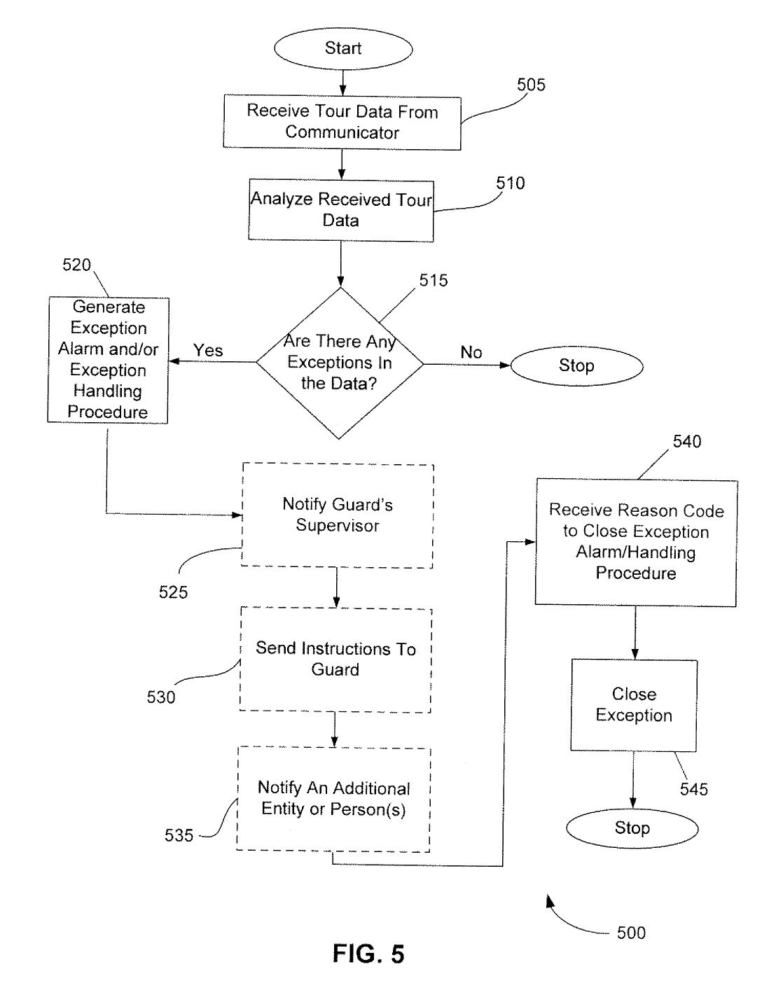

A maintenance exception may be identified if the analysis of received data associated with a guard tour indicates a situation in which maintenance is required at one or more locations along the guard tour. Similar to a security exception, a maintenance exception may be identified based on information that is scanned into the communicator 105 by the guard or manually entered into the communicator 105 by the guard. As with the security exceptions, information may be manually entered into the communicator 105 by the guard via any suitable device, technique, and/or method, for example, via pull down menus of the communicator 105, via a camera included in the communicator 105, via scanning a particular bar code, and/or via voice commands. Example maintenance exceptions may include broken or burned out light bulbs, spills, broken locks, and/or an indication that equipment is operating outside predetermined or preset parameters, as discussed in greater detail below with reference to FIGS. 4-5.

A tour point exception may be identified based on received data that indicates which tour points are visited by the guard during a tour and/or the time at which the tour points were visited. Example tour point exceptions include the non-occurrence of a scheduled tour, one or more missed tour points, and/or visiting one or more tour points outside of a predetermined time interval or range. For example, a missed tour exception may be identified if a guard tour is scheduled for 12:00 a.m. and no tour data is received prior to a threshold time, such as, 12:15 a.m. As another example, a missed tour point exception may be identified if received tour data indicates that a guard visited a tour point prior to visiting one or more tour points that were scheduled to be visited prior to the visited tour point. As yet another example, the data received by the data collection and monitoring center 110 may indicate the times at which each of the tour points was visited by the guard and may then identify time based exceptions associated with the guard tour. For example, the data collection and monitoring center 110 may determine whether or not the guard is completing a tour in a timely fashion. In other words, a predefined time interval may be established for the completion of the tour and/or for the completion of visiting one or more tour points. If a guard takes too long to travel between one or more tour points or to complete the tour, a time based exception may be identified.

In various embodiments of the invention, a guard tour that specifies the order in which tour points are to be visited may be predetermined. Additionally, in various embodiments, more than one predetermined guard tour may be specified. The one or more predetermined guard tours may be stored in a memory associated with the communicator 105 or, alternatively, a predetermined or predefined guard tour may be transmitted to the communicator 105 prior to the initiation of a guard tour. Additionally, in various embodiments of the invention, a guard tour plan may be randomly selected or randomly defined prior to the initiation of a guard tour.

The exceptions described above are merely examples of exceptions that may be identified. Other types of exceptions may be identified as desired in various embodiments of the invention. Additionally, an identified exception may not fit neatly into only one of the earlier described categories. For example, a broken door lock may trigger both a security exception and a maintenance exception.

Once an exception has been identified by the data collection and monitoring center 110, the data collection and monitoring center 110 may communicate information identifying the exception to one or more persons and/or entities. For example, with reference to FIG. 1, the data collection and monitoring center 110 may communicate information identifying a recognized exception to a second communicator 120 via the one or more networks 115. The second communicator 120 may be operated by another guard on the premises or by a supervisor of the guard that is completing the tour. Additionally or alternatively, the data collection and monitoring center 110 may communicate instructions to the second communicator 120 following the identification of an exception. For example, another guard and/or a supervisor may be instructed to respond to a potential security threat. Additionally, the data collection and monitoring center 110 may transmit instructions to the communicator 105 utilized by the guard conducting the tour following the identification of an exception. As an example, the guard may be instructed to lock an unlocked door. As another example, the guard may be instructed to visit a missed tour point. The data collection and monitoring center 110 may communicate with any number of communicators 105, 120 via the network 115. Additionally, instructions or data may be transmitted to a communicator 105, 120 in any appropriate form, such as, a text message, a voice message, and/or an e-mail. According to an aspect of the invention, two-way messaging functionality may be provided between a communicator 105, 120 and the data collection and monitoring center 110 via the one or more networks 115.

The second communicator 120 may include similar components as the first communicator 105. Thus, the second communicator 120 may be any processor-driven device, such as a handheld computer, minicomputer, programmable device, and the like. In addition to having a processor 141, the second communicator 120 may further include a memory 142, input/output (“I/O”) interface(s) 143 and a network interface 144. The memory 142 may store data files 145 and various program modules, such as an operating system (“OS”) 146 and a communications module 147. The communications module 147 may be a software program operable to manage interactions and/or communications with the data collection and monitoring center 110 and/or with the training module 140. The I/O interface(s) 143 may facilitate communication between the processor 141 and various I/O devices associated with the second communicator 120, such as a keypad, touch screen, camera, scanner, RFID reader, and the like. The network interface(s) 144 may take any of a number of forms, such as a network interface card, a modem, a wireless network card, a cellular network card, and the like. One example of a communicator that may be utilized as the second communicator is described in greater detail below with reference to FIG. 2.

Additionally, in certain embodiments of the invention, the data collection and monitoring center 110 may communicate information associated with one or more identified exceptions to one or more persons and/or entities via one or more additional networks. As shown in FIG. 1, the data collection and monitoring center 110 may be in communication with a first network station 125 and a second network station 130 via a second network 135. Although two network stations 125, 130 are illustrated in FIG. 1, the data collection and monitoring center 110 may communicate with any number of network stations via the second network 135. The network stations may be associated with a client whose premises are being monitored and protected by a company conducting the guard tours and/or with a company conducting the guard tours. The second network 135 may be any appropriate network as desired in various embodiments of the invention, for example, a local area network, a wide area network (e.g., the Internet), a cellular network, a conventional telephone network, etc. As an example communication, an e-mail may be communicated to a network station associated with a client when an exception is identified. As another example, an e-mail may be communicated to a network location associated with a manager of the data collection and monitoring center 110 when an exception is identified.

Each of the network stations 125, 130 may be any processor-driven device, such as a handheld computer, minicomputer, programmable device, and the like. As shown in FIG. 1, the first network station 125 may include a processor 151, a memory 152, input/output (“I/O”) interface(s) 153 and a network interface 154. The memory 152 may store data files 155 and various program modules, such as an operating system (“OS”) 156 and a communications module 157. The communications module 157 may be a software program operable to manage interactions and/or communications with the data collection and monitoring center 110. The I/O interface(s) 153 may facilitate communication between the processor 151 and various I/O devices associated with the first network station 125, such as a keypad, touch screen, camera, scanner, RFID reader, and the like. The network interface(s) 154 may take any of a number of forms, such as a network interface card, a modem, a wireless network card, a cellular network card, and the like.

Similarly, the second network station 130 may include a processor 160, a memory 161, input/output (“I/O”) interface(s) 162 and a network interface 163. The memory 161 may store data files 164 and various program modules, such as an operating system (“OS”) 165 and a communications module 166. The communications module 166 may be a software program operable to manage interactions and/or communications with the data collection and monitoring center 110. The I/O interface(s) 162 may facilitate communication between the processor 160 and various I/O devices associated with the second network station 130, such as a keypad, touch screen, camera, scanner, RFID reader, and the like. The network interface(s) 163 may take any of a number of forms, such as a network interface card, a modem, a wireless network card, a cellular network card, and the like.

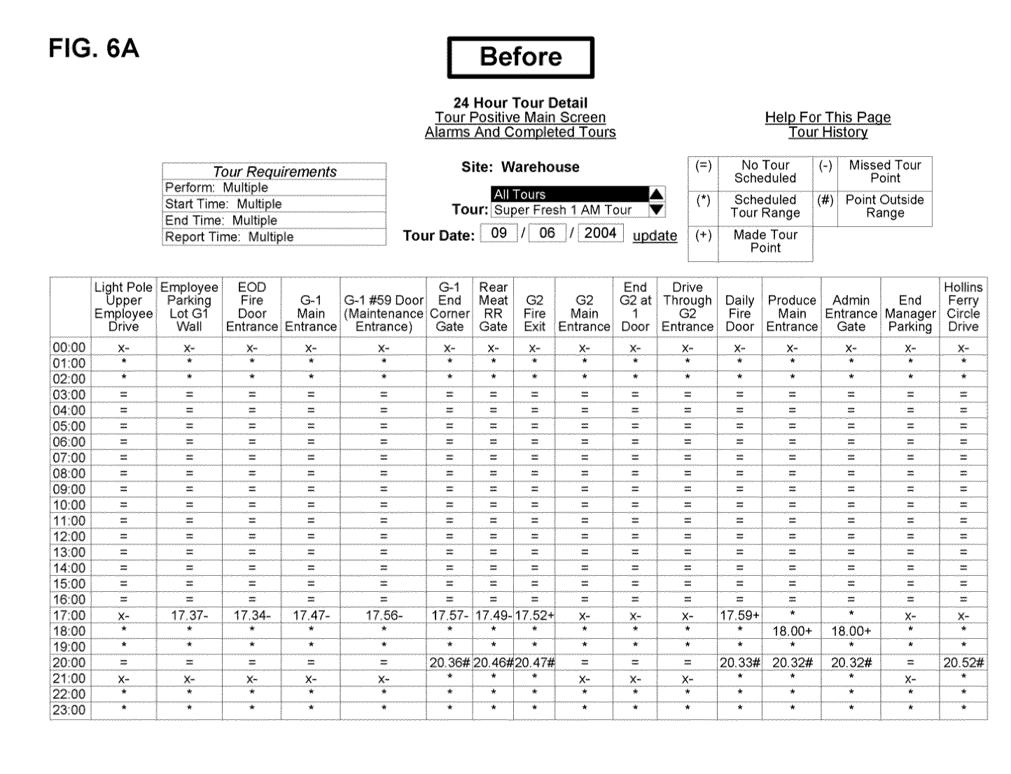

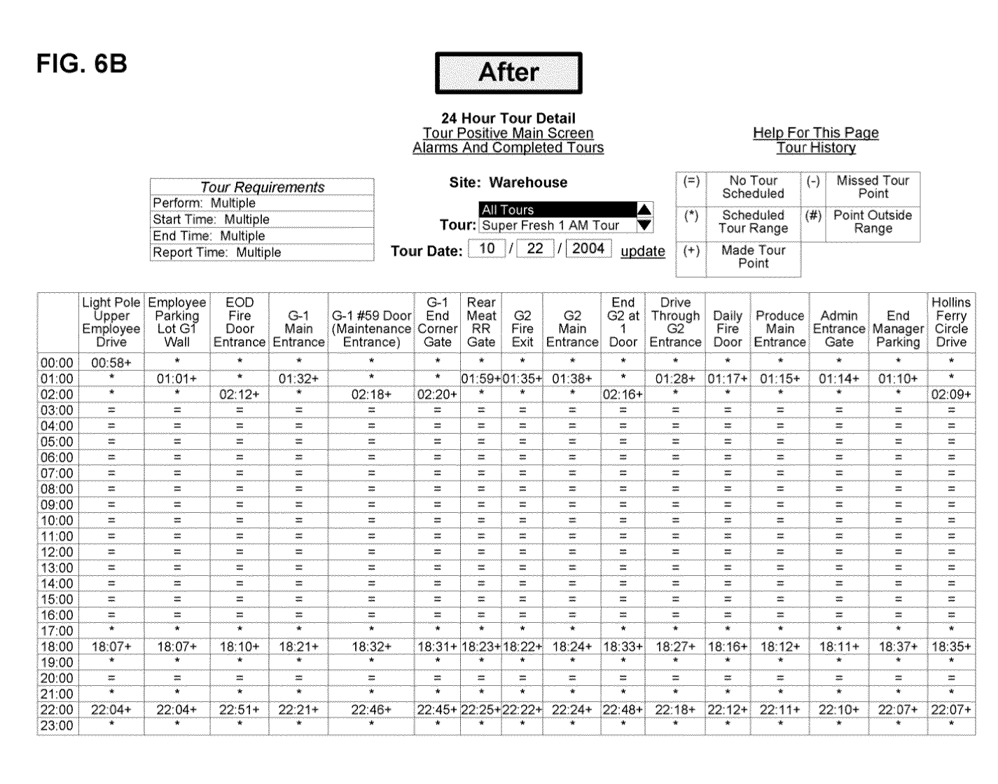

According to an aspect of various embodiments of the invention, the data collection and monitoring center 110 may store data associated with one or more completed guard tours. The data collection and monitoring center 110 may then generate a variety of reports utilizing the stored data, as will be explained in greater detail below with reference to FIG. 6.

Additionally, in accordance with various embodiments of the invention, a training module 140 may be provided. The training module may be operable to transmit or otherwise communicate training questions, training applications, training notices, and/or other information to a communicator, such as communicator 105 or communicator 120 and/or to a telephone, such as telephone 150. In certain embodiments of the invention, the training module 140 may communicate directly with a communicator 105 and/or telephone 150 via the one or more suitable networks 115. Alternatively, in other embodiments of the invention, the training module 140 may communicate with a communicator 105 and/or telephone 150 through the data collection and monitoring center 110. Additionally, in certain embodiments, the training module 140 may communicate with a communicator 105 and/or telephone 150 both directly and via the data collection and monitoring center 110.

A wide variety of different types of training information may be communicated from the training module 140 to a communicator 105 and/or telephone 150. Examples of training information that may be communicated include, but are not limited to, training questions, training tests, training announcements or updates, correct answers for questions, indications of whether received answers our correct, test scores, training questions statistics associated with questions (e.g., the percentage of guards that have answered the question correctly), training question statistics associated with a location (e.g., the percentage of guards at the location that have answered the question correctly), and/or training question statistics associated with a guard (e.g., a guard's overall correct answers score, a guard's correct answer rate for a category of questions, a guard's correct answer rate for the particular question, etc.). Other information may also be communicated from the training module 140 to a communicator 105 and/or telephone 150 as desired in various embodiments of the invention, for example, announcements for the guards. As an example, daily announcements may be communicated to a guard via the communicator 105 and/or telephone 150 when the guard logs into the communicator 105, when the guard begins a guard tour, when the guard completes a guard tour, when the guard clocks in and/or clocks out utilizing the telephone 150, or at any other point of time as desired.

Information may be communicated from the training module 140 to a communicator 105 and/or telephone 150 in a wide variety of different formats as desired in various embodiments of the invention, for example, as text, graphics, verbal communication, messages initiated by an interactive voice recognition (IVR) communications system, or a combination of different formats. Information may also be communicated using a wide variety of different techniques or technologies. For example, information may be communicated as short message service (SMS) messages, via other cellular messaging services, via e-mail, via a web portal, via, cellular voice communication, via conventional telephone voice communication, etc. Additionally, in certain embodiments of the invention, information may be communicated in a wide variety of different languages, for example, English, Spanish, or French. The language for communication may be selected utilizing a wide variety of different techniques. For example, the language may be selected based at least in part on default rules, security company rules, client specific rules, site specific rules, and/or guard specific rules stored in a suitable memory associated with the training module, such as database 180. As another example, the language may be selected based at least in part on a preference received from the guard via the communicator 105 or telephone 150, such as, a guard selection made via a pull down menu presented to the guard by the communicator, a guard selection made utilizing touch tone selection, or via the receipt of a voice command.

According to certain embodiments of the invention, the training module 140 may communicate one or more questions to a communicator 105 and/or telephone 150 to be answered by a guard. The guard may enter answers to the one or more questions into the communicator 105 or telephone 150, and the communicator 105 or telephone 150 may communicate the entered answers back to the training module 140. Questions may be answered in a wide variety of different ways as desired in various embodiments of the invention, for example, via selection of an appropriate button on a keypad, via voice input that is deciphered by a voice recognition component of the training module 140, vie selection from a pull down menu, etc. The training module 140 may receive the guard's answers to the one or more questions and determine whether the guard has answered the one or more questions correctly. The training module 140 may then communicate one or more indications of whether the one or more questions were answered correctly to the communicator 105 or telephone 150. The training module 140 may also communicate statistics to the communicator 105 or telephone 150 associated with the answered questions and/or associated with historical data for questions answered by the guard and/or by other guards.

In addition to communicating statistics to the communicator 105 or telephone 150 associated with a guard that answered the one or more questions, the training module 140 may additionally or alternatively communicate statistics to one or more other devices. For example, the training module 140 may communicate statistics to one or more other communicators, such as a communicator 120 associated with a guard's supervisor, and/or to one or more network stations, such as network stations 125 and 130. The one or more network stations may be associated with a security company that employs the guards and/or with a client of the security company. In this regard, a guard's supervisor, employer, and/or client may monitor the guard's and other guards' progress in answering training questions. Corrective action may then be taken in a timely manner if necessary. Additionally, in some embodiments, the training module 140 may enroll the guard for additional training sessions, classes, and/or seminars based at least in part n the guard's history of answering one or more questions.

The one or more questions communicated by the training module 140 may be accessed from one or more question banks stored in one or more suitable memories and or data repositories associated with the training module, such as one or more databases 180. Any number of questions may be stored in the one or more question banks as desired in various embodiments of the invention. In one example embodiment of the invention, 25 questions may be stored for a client site. Additionally, respective correct answers may be stored in association with each of the questions. The questions stored in the question bank(s) may be general questions and/or questions that are specific to a client or client site. Additionally, the questions may be arranged into a variety of different categories as desired.

The questions may be accessed and selected from the one or more question bank(s) based at least in part on a wide variety of different access rules and/or parameters, for example, a predetermined order, rules that specify that each question shall be asked before a question is repeated, client preferences, past history of answering one or more questions, a specific guard's past history of answering one or more questions, recent changes to policy or operating procedures, and/or upcoming changes to policy or operating procedures. As an example, a question may be selected for a guard based on the guard's history of incorrect answers to the question or to similar questions. Alternatively, a category of questions may be selected based on a wide variety of different access rules or parameters, and one or more questions may be randomly selected from the category. A category may also be randomly selected. Alternatively, one or more questions may be randomly selected from a general pool of questions or across multiple categories.

Questions may be communicated by the training module 140 in association with a wide variety of different triggers. Examples of triggers that may be utilized in various embodiments of the invention include, but are not limited to, a guard logging into a communicator 105, a guard logging out of the communicator 105, beginning a guard tour, completing a guard tour, beginning a break, ending a break, clocking in for the day utilizing the communicator 105 or the telephone 150, clocking out utilizing the communicator 105 or the telephone 150, etc. Additionally or alternatively, questions may be communicated by the training module 140 in association with a specific access of the training module 140 by a guard, for example, the guard establishing a direct communication link (e.g., calling, texting, pulling up a web browser) between a communicator 105 or telephone 150 and the training module 140. According to one embodiment, a guard's time on the job may be tracked in accordance with when a guard logs into and logs out of a communicator 105 or when the guard clocks in and clocks out utilizing the communicator 105 or the telephone 150. The guard may be communicated training questions and/or other information at one or more of the login, logout, clocking in, or clocking out. In this regard, the guard may receive regular ongoing training.

In one embodiment, training questions communicated to a guard communicator 105 or telephone 150 may be true/false and/or multiple choice questions. A question and potential answers to the question may be presented to the guard via the communicator 105 or telephone 150. The guard may then utilize one or more suitable I/O devices, for example, a keypad, touch screen, etc., to select an answer to the question. The answer may then be communicated to the training module 140.

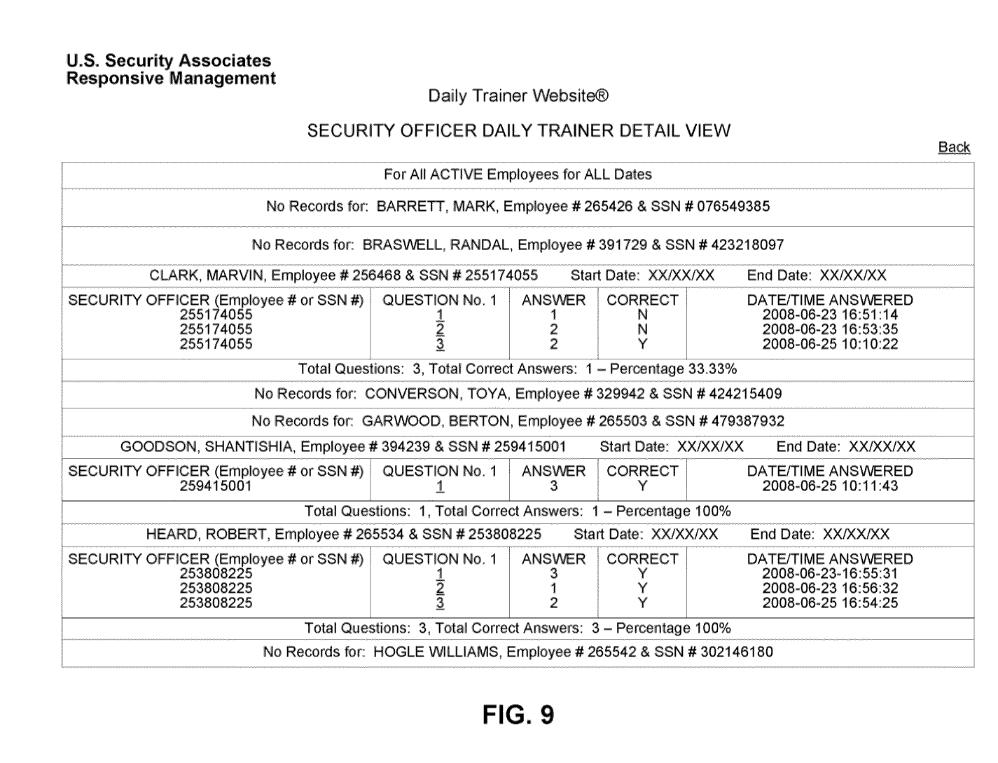

In certain embodiments of the invention, answers received from communicators and/or telephones associated with one or more guards may be stored by the training module 140 in one or more suitable memories, such as, in database 180. The stored answers may be utilized to generate a wide variety of different reports as desired in various embodiments of the invention. One example report is discussed below with reference to FIG. 9.

FIG. 2 is block diagram of one example communicator 200 that may be utilized in accordance with the guard tour system 100 of FIG. 1, according to an illustrative embodiment of the invention. For example, the communicators 105, 120 illustrated in FIG. 1 may include similar components as the communicator 200 shown in FIG. 2. The communicator 200 may be a digital communicator that is operable to communicate over a cellular network. In other words, the communicator 200 may include the functionality of a cellular telephone. The communicator 200 may be any appropriate device that is configured to collect or gather data associated with a guard tour during a guard tour. The communicator 200 may also be any appropriate device that is configured to display training questions and receive answers to the training questions from a guard. The communicator 200 may include a communicator control unit 205 and a memory 210. The communicator control unit 205 may control the operation of the communicator 200. The communicator control unit 205 may include any appropriate processing device or combination of processing devices, such as, a microcontroller, a minicomputer, an EPROM, or a processor. Further, the communicator control unit 205 may include software, hardware, firmware or any combination thereof. The memory 210 may be in communication with the communicator control unit 205, and the memory 210 may be operable to store data gathered by the communicator 200 and/or programmed logic that is executable by the communicator control unit 205. The memory 210 may include any appropriate electronic storage device or combination of devices as desired in various embodiments of the invention, for example, a random access memory (RAM), a flash memory, or a magnetic data storage device.

The communicator control unit 205 may also incorporate or be in communication with one or more input/output (I/O) interfaces 215. The one or more I/O interfaces 215 may facilitate communication between the communicator control unit 205 and other components of the communicator 200 or with external devices. The one or more I/O interfaces 215 may facilitate communication between the communicator control unit 205 and components of the communicator 200 that are operable to gather or collect data.

According to one embodiment of the invention, the communicator 200 may include one or more data collection devices that may be in communication with the communicator control unit 205 via the one or more I/O interfaces 215. With reference to FIG. 2, the communicator 200 may include or incorporate one or more scanners 220, one or more cameras 225, and one or more keypads 230. Other data collection devices may be incorporated into the communicator 200 or be in communication with the communicator 200, such as, data ports, disk drives, network access points, touch pads, touch screens, selectable displays, microphones, and/or voice recognition programs or software.

According to one embodiment of the invention, the one or more scanners 220 may include a barcode scanner that is operable to scan a unique barcode associated with each tour point on a guard tour. Many different types of scanning devices and/or scanning techniques may be incorporated into or in communication with the communicator 200 as desired in various embodiments of the invention. For example, certain embodiments of the communicator 200 may utilize a camera 225 to scan a smart label or a barcode that is designed to be scanned by the camera 225 and/or to take pictures during a guard tour, for example, pictures of damage to a trailer. Other types of potential scanning devices will be readily apparent to those of skill in the art, for example, optical scanners.

In certain embodiments of the invention, the scanners 220 may include one or more suitable scanners for receiving biometric data associated with a guard or other user of the communicator 220. For example, the scanners 220 may include a digital fingerprint scanner and or a digital retinal scanner. Other types of biometric data scanners may be utilized in other embodiments of the invention as desired. In this regard, a guard or other user of the communicator 200 may be identified and or validated as an authorized user based at least in part on biometric data.

Each of the one or more cameras 225 may be any suitable device that is operable to record a digital image and/or a digital video. The one or more cameras 225 may be utilized to record images and/or videos associated with a guard tour. For example, the one or more cameras 225 may be utilized to record one or more images of maintenance conditions and/or security conditions identified during a guard tour. Many different types of images associated with a guard tour may be recorded by the one or more cameras 225 as desired in various embodiments of the invention.

According to certain embodiments of the invention, the communicator 200 may include at least one video driver 235 and at least one display 240. The communicator control unit 205 may be operable to communicate data to a video driver 235, and the video driver 235 may be operable to drive an output to a display 240. A display 240 may be operable to present data to the guard that is utilizing the communicator 200. The display 240 may be any type of appropriate display, for example, a liquid crystal display (LCD). The display 240 may be operable to display instructions to the guard, including instructions that are associated with a vehicle yard tour. Additionally, the display 240 may be operable to display instructions to the guard that are received from a data collection and monitoring center, such as data collection and monitoring center 110, and/or from a training module, such as training module 140. The display 240 may also be operable to display various menu options to a guard that are utilized during the completion of a guard tour. The display 240 may additionally be operable to display training questions, training announcements, and the like to a guard. The display 240 may further be operable to display to the guard information or data that has been entered into the communicator 200 by the guard. For example, the display 240 may be operable to present text that has been entered by the guard. As another example, the display 240 may be operable to present a picture that has been taken with the camera 225 to the guard.

With continued reference to FIG. 2, the communicator 200 may also include one or more network interfaces 245 that are in communication with the communicator control unit 205. Each of the one or more network interfaces 245 may be any suitable interface that facilitates communication between the communicator 200 and other components of a guard tour system, such as guard tour system 100. Many different types of network interfaces may be incorporated into the communicator 200 as desired in various embodiments of the invention. For example, the one or more network interfaces 245 may include a cellular network interface that facilitates communication with a data collection and monitoring center 110 via a cellular network, for example, the cellular network 115 discussed above with reference to FIG. 1.

A wide variety of devices may be utilized as desired to function as a communicator 200 in a guard tour system 100. One example device may be a Motorola i355 device that incorporates or is in communication with one or more scanners. Another example device may be a Motorola i580 device that incorporates or is in communication with one or more scanners. Other example devices can be utilized by other embodiments of the invention.

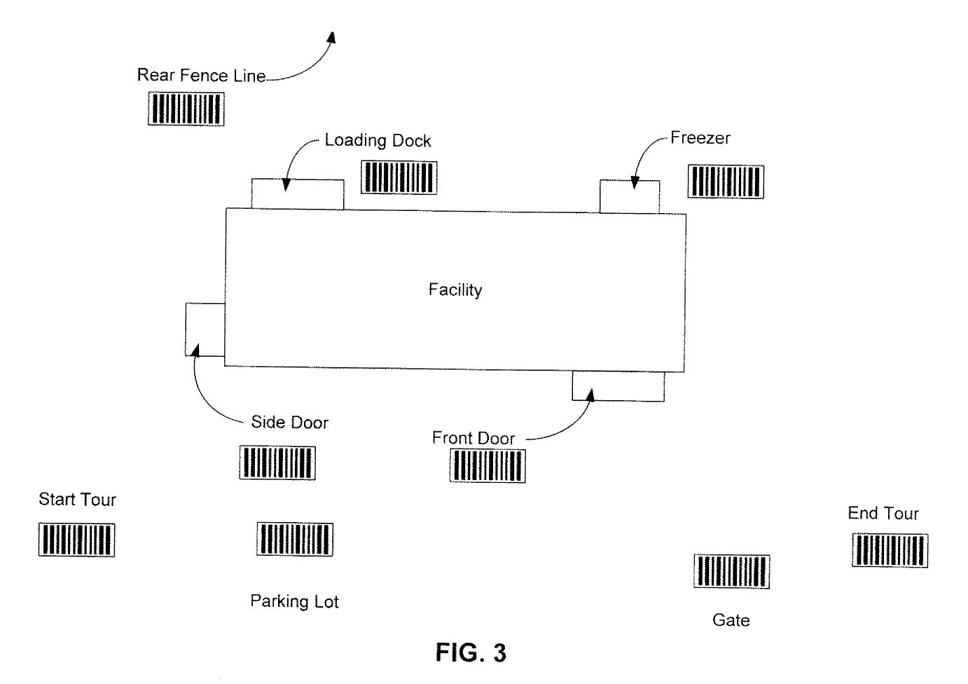

FIG. 3 is a schematic diagram of one example guard tour that may be conducted utilizing a guard tour system, such as the guard tour system 100 of FIG. 1, according to an illustrative embodiment of the invention. As shown in FIG. 3, a variety of tour points may be established at a premises that is monitored by the guard tour system 100. Each tour point may include one or more bar codes that may be scanned during the completion of a guard tour. A guard may visit each of the tour points during the completion of the guard tour. By scanning each bar code, it may be determined that a guard is completing a guard tour in a timely manner. Exceptions may be identified if tour points are skipped or not reached in a timely manner. Additionally, the scanning of a bar code may prompt the guard to enter additional information associated with the tour point, as explained in greater detail below with reference to FIG. 4.

FIG. 4 is a flowchart depicting one example method 400 of the operation of a communicator utilized in conjunction with a guard tour system, according to an illustrative embodiment of the invention. The communicator, such as communicator 105 illustrated in FIG. 1, may include one or more control units that execute the operations depicted in FIG. 4 in accordance with programmed control logic. Prior to the commencement of a guard tour, a guard tour plan may be presented to the guard by the communicator 105. When a tour is commenced, a guard may proceed with the communicator 105 to the next tour check point at block 405. Once the next check point is reached, the guard may utilize a scanner of the communicator 105, such as scanner 220 illustrated in FIG. 2, to scan a bar code strip associated with the tour check point at block 410.

Following the scanning of the bar code strip, the communicator 105 may determine at block 415 whether or not any additional input is required. If it is determined that no additional information is required, then operations may continue at block 430. If, however, it is determined at block 415 that additional input is required, then operation may continue at block 420, and the guard may be prompted for the additional information. The guard may be prompted for many different types of information, for example, information concerning the current operation of equipment. Following the prompting of the guard for additional input at block 425, the communicator 105 may receive the input at block 425 and operations may proceed to block 430.

At block 430, the communicator 105 may transmit or otherwise communicate collected information to a data collection and monitoring center, such as data collection and monitoring center 110. Once the data has been transmitted to the data collection and monitoring center 110, the communicator 105, at block 435, may optionally receive data and/or instructions from the data collection and monitoring center 110 in response to the transmitted data. A portion or all of the data or instructions received at block 435 may be displayed to the guard by the communicator 105.

At block 440, a determination may be made as to whether or not the guard tour is complete. If it is determined that the guard tour has not been completed, then operation may continue at block 405 and the guard may be instructed to proceed to the next tour checkpoint. If, however, at block 440, it is determined that the guard tour has been completed, then operations may cease until the next scheduled guard tour.

The operations described and shown in FIG. 4 may be carried out or performed in any suitable order as desired in various embodiments of the invention. Additionally, in certain embodiments, less than or more than the operations described in FIG. 4 may be performed.

FIG. 5 is a flowchart depicting one example method 500 of the operation of a monitoring system, such as the data collection and monitoring center 110 shown in FIG. 1, utilized in conjunction with a guard tour system, such as guard tour system 100, according to an illustrative embodiment of the invention. The data collection and monitoring center 110 may include one or more control units that execute the operations depicted in FIG. 5 in accordance with programmed control logic. For example, the data collection and monitoring center 110 may include one or more personal computers, server computers, and/or mainframe computers that execute the logic depicted in FIG. 5.

With reference to FIG. 5, at block 505, the data collection and monitoring center 110 may receive data associated with an ongoing or completed guard tour from a communicator, such as communicator 105 shown in FIG. 1. Following the receipt of data at block 505, the operations of the data collection and monitoring center 110 may proceed to block 510 and the received tour data may be analyzed for exceptions. At block 515, a determination may be made as to whether or not any exceptions are identified in the tour data. If no exceptions are identified, then operations may cease until additional tour data is received. If, however, exceptions are identified at block 515, then the operations of the data collection and monitoring center 110 may proceed to block 520. At block 520, an alarm associated with each identified exception may be generated. Additionally, an exception handling procedure may be initiated for each of the identified exceptions. An alarm and an exception handling procedure may remain open until an appropriate reason code is entered at the data collection and monitoring center 110 to close the exception alarm and/or the exception handling procedure.

A generated exception handling procedure may be configured to contact one or more persons and/or entities regarding an exception. Accordingly, an exception handling procedure may be configured to escalate an exception over time until an appropriate reason code is entered to close the exception alarm and/or the exception handling procedure. An example exception handling procedure is described in U.S. patent application Ser. No. 11/218,175, entitled “Supervised Guard Tour Tracking Systems and Methods,” the disclosure of which is incorporated by reference herein in its entirety. The generated exception handling procedure may send notifications and/or instructions concerning the identified exception. The notifications and/or instructions may include many different types of messages, for example, text messages, e-mails, and voice messages. Shown in FIG. 5 as operations that may be optional in certain embodiments of the invention, the data collection and monitoring center 110 may notify a guard's supervisor of an identified exception at block 525. The guard's supervisor may then follow-up on the identified exception with the guard that is conducting the guard tour. For example, if the exception identified a missed tour point, then the guard's supervisor may meet with the guard and explain the importance of visiting every point on the guard tour. The data collection and monitoring center 110 may also send instructions to a guard at block 530 as part of an exception handling procedure. Utilizing the example above, the guard may be instructed to visit a missed tour point. As another example, a guard may be instructed to contact the police if a security exception has been identified. The data collection and monitoring center 110 may also notify one or more additional entities or persons as part of an exception handling procedure at block 535. For example, the data collection and monitoring center 110 may notify a client whose premises are being guarded when an exception is identified. As another example, the data collection and monitoring center 110 may notify a maintenance supervisor when a maintenance exception is identified.

At block 540, a reason code may be received by the data collection and monitoring center 110. In response to the received reason code, the exception alarm and/or exception handling procedure may be closed at block 545. Once all of the open exception alarms and exception handling procedures have been closed, the operations of the method 500 may cease until additional tour data is received.

The operations described and shown in FIG. 5 may be carried out or performed in any suitable order as desired in various embodiments of the invention. Additionally, in certain embodiments, less than or more than the operations described in FIG. 5 may be performed.

According to certain embodiments of the invention, an escalation system may also be utilized to monitor the receipt of notifications or messages that are transmitted to one or more individuals and/or entities. For example, an escalation system may be utilized to monitor the receipt of messages that are sent to the guard, messages that are sent to the guard's supervisor, and/or messages that are sent to a client. The message escalation system may be utilized to ensure that a notifications or message is delivered and that a response is received for the message. As an example, an message may be transmitted to a guard once an exception is identified. If a reply is not received from the guard for a predetermined period of time, then the message may be escalated. Any predetermined period of time may be utilized as desired in various embodiments of the invention, such as, five minutes.

Once a message has been escalated, an additional message may be transmitted by the escalation system. One or more additional messages may be transmitted to various individuals and/or entities until an appropriate reply is received. For example, a second message may be transmitted to the guard by the escalation system. Additionally and/or alternatively, a second message may be transmitted to a next contact person selected from a predetermined contact list such as, for example, the guard's supervisor. The message system may continue to escalate messages until a reply is received. For example, if a reply is not received from the guard's supervisor, a message may be transmitted to a security company supervisor and, if a reply is not received from the security company supervisor, a message may be transmitted to a client or owner of the property on which the guard tour is being conducted, and so on until a reply is received. Additionally, any number of messages may be transmitted or communicated at each escalation level. Furthermore, a contact list may be a generic contact list or a contact list that is specific to one or more types of identified exceptions. For example, a different contact list may be defined for a maintenance exception and a security exception.

According to another aspect of the invention, the data collection and monitoring center 110 may utilize the collected tour data in order to generate a wide variety of different reports. Example reports are depicted in FIGS. 6A and 6B. FIG. 6A is a first example graphical user interface depicting data collected during a guard tour, according to an illustrative embodiment of the invention. In the columns of FIG. 6A, the various tour points associated with a guard tour are depicted. In the rows of FIG. 6A, scheduled guard tours are depicted. In the example of FIG. 6A, guard tours were scheduled every hour from five o'clock p.m. until two o'clock a.m. For each completed tour, the point in time at which a tour point was visited is depicted. Due to the ability of the communicator to present a different tour path to a guard prior to the commencement of a tour, the tour points of two different tours may have been visited in different orders. Accordingly, in FIG. 6A, the times at which various tour points were visited may not be presented in a sequential order in accordance with the established columns of FIG. 6A.

In addition to the time at which a tour point was visited, other data may be presented in the graphical user interface of FIG. 6A. For example, a missed tour point may be identified. As another example, a tour point that was visited outside of a predetermined time range may be identified. Finally, one or more scheduled tour points that have not yet been visited may be identified in FIG. 6A.

As shown in FIG. 6A, a guard that is conducting a guard tour may not complete the tour in a timely and efficient manner. However, the communicator 105 and the data collection and monitoring center 110 may monitor a guard's progress and send instructions to a guard when a tour is not being completed in a timely manner. Accordingly, the expectations for a guard's performance may be reinforced and the guard may be incentivized to complete tours in a timely manner.

FIG. 6B is a second example graphical user interface depicting data collected during a guard tour, according to an illustrative embodiment of the invention. FIG. 6B illustrates an example report that may be generated after an embodiment of the invention has been installed at a client site. Over time, a guard may learn the type of behavior that is expected through reinforcement and instructions received in accordance with embodiments of the invention. Accordingly, a guard may begin to complete guard tours in a timely and efficient manner.

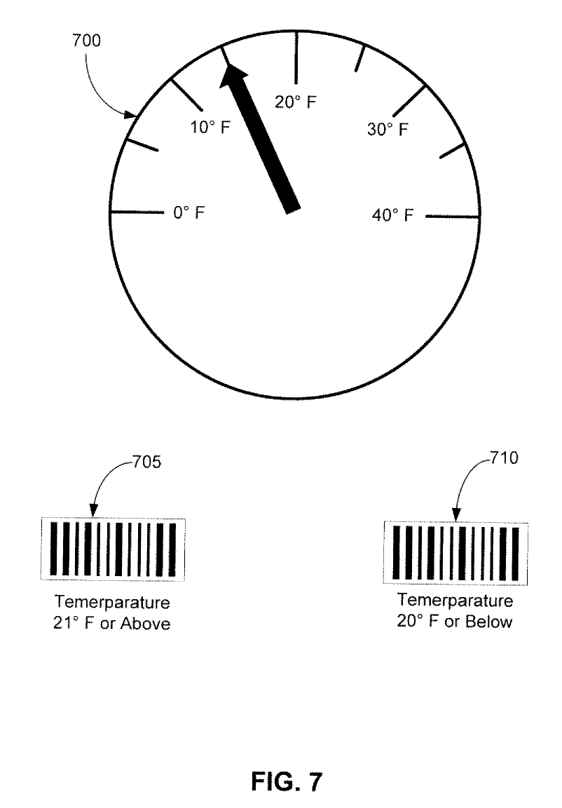

According to various embodiments of the invention, at one or more guard tour points, a guard may be prompted for additional information concerning the tour point, as shown in block 420 of FIG. 4. For purposes of the present disclosure, such a tour point may be referred to as an inspection point. FIG. 7 is one example inspection point 700 for a guard tour, according to an illustrative embodiment of the invention. In the example of FIG. 7, the inspection point 700 is associated with a freezer that is situated along the path of the guard tour. Operating parameters may be predefined for the freezer. For example, the temperature of the freezer may need to be maintained at or below 20 degrees Fahrenheit. Following the scanning of a bar code at the inspection point, the guard may be prompted to enter additional information associated with the operating condition of the freezer. For example, the guard may be prompted to enter information associated with the operational temperature of the freezer. The guard may enter the temperature related information in a variety of ways. For example, the guard may utilize an input device 220 of the communicator 105 to enter a current operational temperature of the freezer. In the example, shown in FIG. 7, one or more additional bar codes may be provided at the inspection point, and a guard may be required to scan at least one of the additional bar codes in order to enter the additional information. For example, a first additional bar code 705 may be scanned if the operational temperature of the freezer is greater than approximately twenty degrees Fahrenheit. Alternatively, a second additional bar code 710 may be scanned if the operational temperature of the freezer is approximately twenty degrees Fahrenheit or below. Once the additional information is entered into the communicator 105, it may be transmitted to the data collection and monitoring center 110. The data collection and monitoring center 110 may then analyze the additional information in order to identify a maintenance exception associated with the freezer. For example, if the operational temperature of the freezer is thirty degrees Fahrenheit, then the data collection and monitoring center 110 may trigger an exception handling procedure that contacts a maintenance supervisor in order to repair the freezer.

An example of another type of inspection point may be a guard tour point at which a fire extinguisher is located. Periodically, a guard may be asked to examine the expiration data of a fire extinguisher located at the guard tour point. For example, a guard may be asked to examine the expiration date at the first of every month. The guard may utilize an input device 220 of the communicator 105 in order to enter the expiration date of the fire extinguisher. The expiration date may then be transmitted to the data collection and monitoring center 110 and analyzed for exceptions.

In certain embodiments of the invention, additional information associated with an inspection point may be transmitted to the data collection and monitoring center 110 separate from the tour point information collected by the communicator 105. Alternatively, the additional information and the tour point information may be transmitted to the data collection and monitoring center 110 as part of a single data transmission or data file.

According to certain embodiments of the invention, a guard may utilize a camera of the communicator 105, such as camera 225 in order to take a photograph associated with a maintenance exception and/or a security exception. The photograph may illustrate a maintenance problem, security breach, or safety hazard. For example, a photograph of a security breach that includes a broken fence may be identified by a guard conducting a tour. Following the identification of the security breach, the guard may take a photograph of the security breach. The photograph may be transmitted to the data collection and monitoring center 110 and the photograph may be attached to any messages created as part of a generated exception handling procedure. An exception handling procedure may be generated, and one or more persons or entities may be contacted in accordance with the generated exception handling procedure. The photograph may be attached to messages created by the exception handling procedure. For example, an e-mail may be generated to a maintenance manager and the photograph may be attached to the e-mail. As another example, a message may be transmitted to a guard supervisor and the photograph may be attached to the transmitted message.

In certain embodiments of the invention, pictures or other images may be transmitted to the data collection and monitoring center 110 separate from the tour point information collected by the communicator 105. Alternatively, a picture and the tour point information may be transmitted to the data collection and monitoring center 110 as part of a single data transmission or data file.

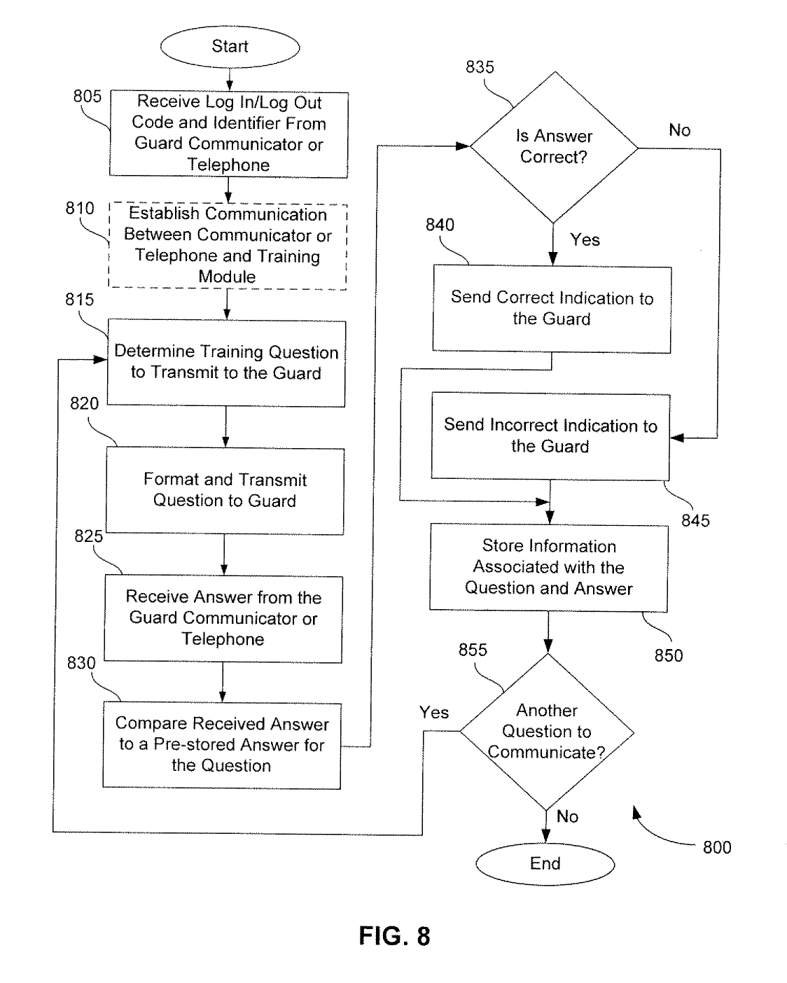

FIG. 8 is a flowchart of one example method 800 for presenting one or more training questions to a guard, in accordance with an illustrative embodiment of the invention. The example method 800 may be operable to communicate one or more training questions to a guard based at least in part on a training module, such as module 140, receiving login and/or logout information or clock in and/or clock out information for a guard that is entered into a communicator, such as, communicator 105 or into a telephone, such as telephone 150. In certain embodiments, the login/logout or clock in/clock out information may be received by a guard monitoring center or a data collection and monitoring center, and the guard may then be linked to the training module 140. The method 800 may begin at block 805.

At block 805, login, logout, clock in, or clock out information from a guard communicator 105 or telephone 150 may be received. The login or logout code may be utilized to identify the guard utilizing the communicator 105 or telephone 150. Alternatively, a guard identifier may be received from the communicator 105 or telephone 150 that identifies the guard.

In certain embodiments of the invention, the login, logout, clock in, or clock out information or code and/or the identifier may be received by a guard monitoring center or by a data collection and monitoring center, such as data collection and monitoring center 110. The data collection and monitoring center 110 may then facilitate communication between the communicator 105 or telephone 150 and the training module 140. The data collection and monitoring center 110 may act as an intermediary between the communicator 105 or telephone 150 and the training module 140. Alternatively, as shown in block 810, the data collection and monitoring center 110 may facilitate the establishment of direct communication between the communicator 105 or telephone 150 and the training module 140, for example, by passing a communication session to the training module 140. Additionally, in certain embodiments of the invention, the communicator 105 or telephone 150 may communicate directly with the training module 140 without communicating with the data collection and monitoring center 110 or with any other type of guard monitoring center.

At block 815, the training module 140 may determining a training question to transmit to the communicator 105 or telephone 150. The selection or determination of a training question may be based at least in part on a wide variety of different preferences and/or parameters, as discussed in greater detail above with reference to FIG. 1. Once a training question has been selected or otherwise determined, the training question may be formatted and transmitted to the communicator 105 or telephone 150 at block 820. The training question may be formatted in a wide variety of different ways and/or in a wide variety of different languages. Additionally, the training question may be communicated in accordance with a wide variety of different communication protocols, for example, via voice communication, via SMS or via a web portal.

The training question may be presented to the guard at the communicator 105 or telephone 150, and the guard may enter an answer into the communicator 105 or telephone 150 that is communicated back to the training module 140. The answer may be received by the training module 140 at block 825. At block 830, the received answer may be compared to a pre-stored answer for the question. At block 835, a determination may be made as to whether the answer received from the guard is correct. If it is determined at block 835 that the answer is correct, then operations may continue at block 840 and an indication that the question was answered correctly may be communicated to the guard communicator 105 or telephone 150. Operations may then proceed to block 850. If, however, it is determined at block 835 that the answer is incorrect, then operations may continue at block 845 and an indication that the question was answered incorrectly may be communicated to the guard communicator 105 or telephone 150. Operations may then proceed to block 850.

At block 850, information associated with the question and the received answer may be stored by the training module 140 in one or more suitable memory devices, such as in database 180 illustrated in FIG. 1. Operations may then proceed to block 855 and a determination may be made as to whether another question should be communicated to the guard communicator 105 or telephone 150. For example, training parameters may indicate that the guard should be asked more than one question. For example, the guard may be asked two questions each time the guard logs in to the communicator 105 or telephone 150. As another example, a guard may be presented with a follow-up question based at least in part on the answer provided to a previous question.

If it is determined at block 855 that another question should be communicated, then operations may proceed to block 815 and another training question may be selected for communication to the guard communicator 105 or telephone 150. If, however, it is determined at block 855 that no more questions should be communicated to the guard, then operations of the method 800 may end.

The operations described and shown in FIG. 8 may be carried out or performed in any suitable order as desired in various embodiments of the invention. Additionally, in certain embodiments, less than or more than the operations described in FIG. 8 may be performed.

According to certain embodiments of the invention, a wide variety of different reports may be generated based at least in part on the answers received from one or more guards by a training module, such as training module 140. FIG. 9 illustrates one example report that may be generated. As shown in FIG. 9, questions and answers that are presented to and received from a plurality of different guards may be displayed. Additionally, an indication of whether the answer was correct and a correct percentage may be displayed. With continued reference to FIG. 9, the date and time at which each question is answered may be displayed. This information may be received from the communicator 105 with an answer or, alternatively, may be determined by the training module 140. In various embodiments of the invention, reports may be generated for one or more guards employed by a security company and/or for one or more guards assigned to a client or a particular client site. In this regard, the ongoing training of a guard may be monitored and corrective action may be taken if it is deemed to be desirable. For example, with reference to FIG. 9, corrective action may be taken for the first guard based on the guard's relatively low percentage of total correct answers. Examples of corrective action may be monitoring a supervisor of the low percentage, communicating additional questions and/or training material to the guard, and/or enrolling the guard for additional training classes.

The invention is described above with reference to block and flow diagrams of systems, methods, apparatuses, and/or computer program products according to example embodiments of the invention. It will be understood that one or more blocks of the block diagrams and flow diagrams, and combinations of blocks in the block diagrams and flow diagrams, respectively, can be implemented by computer-executable program instructions. Likewise, some blocks of the block diagrams and flow diagrams may not necessarily need to be performed in the order presented, or may not necessarily need to be performed at all, according to some embodiments of the invention.

These computer-executable program instructions may be loaded onto a general purpose computer, a special-purpose computer, a processor, or other programmable data processing apparatus to produce a particular machine, such that the instructions that execute on the computer, processor, or other programmable data processing apparatus create means for implementing one or more functions specified in the flowchart block or blocks. These computer program instructions may also be stored in a computer-readable memory that can direct a computer or other programmable data processing apparatus to function in a particular manner, such that the instructions stored in the computer-readable memory produce an article of manufacture including instruction means that implement one or more functions specified in the flow diagram block or blocks. As an example, embodiments of the invention may provide for a computer program product, comprising a computer usable medium having a computer readable program code or program instructions embodied therein, said computer readable program code adapted to be executed to implement one or more functions specified in the flow diagram block or blocks. The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions and program instruction means for performing the specified functions. It will also be understood that each block of the block diagrams and flow diagrams, and combinations of blocks in the block diagrams and flow diagrams, can be implemented by special-purpose, hardware-based computer systems that perform the specified functions, elements or steps, or combinations of special purpose hardware and computer instructions.

While the invention has been described in connection with what is presently considered to be the most practical and various embodiments, it is to be understood that the invention is not to be limited to the disclosed embodiments, but on the contrary, is intended to cover various modifications and equivalent arrangements included within the spirit and scope of the appended claims.

This written description uses examples to disclose the invention, including the best mode, and also to enable any person skilled in the art to practice the invention, including making and using any devices or systems and performing any incorporated methods. The patentable scope the invention is defined in the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

The claimed invention is:

1. A guard training system, comprising:
a telecommunications node situated at a guard location, the telecommunications node operable to facilitate the presentation of training questions to a guard situated at the guard location; and
a training module operable to:
determine one or more training questions to communicate to the telecommunications node based at least in part on a predetermined condition;
communicate the one or more training questions to the telecommunications node via a network;
receive a respective answer to each of the one or more training questions from the telecommunications node; and
determine whether the received answers are correct.

2. The guard training system of claim 1, wherein the predetermined condition comprises one of a clocking in by the guard, a clocking out by the guard, a log-in by the guard to a device utilized to complete a guard tour, or a commencement of a guard tour.

3. The guard training system of claim 1, wherein the training module is further operable determine and store one or more statistics based at least in part on the received answers.

4. The guard training system of claim 1, wherein the training module is operable to determine one or more training questions based at least in part on answers previously received from the telecommunications node.

5. The guard training system of claim 1, wherein the telecommunications node comprises a communicator operable to collect data associated with one or more tour points of a guard tour.

6. The guard training system of claim 5, wherein the communicator is further operable to transmit the collected data via the network to a monitoring center at a point in time proximate to the time at which the data is collected at each of the one or more tour points.

7. The guard training system of claim 6, wherein the monitoring center is further operable to identify at least one exception based on the collected data and to transmit a message to the communicator based at least in part on the identified at least one exception.

8. A method for training a security guard, the method comprising:
determining one or more training questions for presentation to a guard based at least in part on identifying a predetermined condition;
communicating the one or more training questions to a telecommunications node situated at a guard location for presentation to the guard;
receiving a respective answer to each of the one or more training questions from the telecommunications node; and
determining whether the received answers are correct,
wherein the above steps are performed by one or more computers associated with a guard training system.

9. The method of claim 8, wherein the predetermined condition comprises one of a clocking in by the guard, a clocking out by the guard, a log-in by the guard to a device utilized to complete a guard tour, or a commencement of a guard tour.

10. The method of claim 8, further comprising:
determining and storing one or more statistics based at least in part on the received answers.

11. The method of claim 8, determine one or more training questions comprises determining one or more training questions based at least in part on answers previously received from the telecommunications node.

12. The method of claim 8, wherein communicating the one or more questions to a telecommunications node comprises communicating the one or more questions to a communicator operable to collect data associated with one or more tour points of a guard tour.

13. The method of claim 12, further comprising:
receiving, at a monitoring center from the communicator via the network, the collected data at a point in time proximate to the time at which the data is collected at each of the one or more tour points.

14. The method of claim 13, further comprising:
identifying at least one exception based on the collected data; and
communicating a message to the communicator based at least in part on the identified at least one exception.

15. A guard training system, comprising:
a communicator operable to collect data associated with one or more tour points of a guard tour and further operable to display training questions to a guard utilizing the communicator; and
a training module operable to:
determine one or more training questions to communicate to the guard based at least in part on a predetermined condition;
communicate the one or more training questions to the communicator via a network;
receive a respective answer to each of the one or more training questions from the communicator; and
determine whether the received answers are correct.

16. The guard training system of claim 15, wherein the predetermined condition comprises one of a clocking in by the guard, a clocking out by the guard, a log-in by the guard to a device utilized to complete a guard tour, or a commencement of a guard tour.

17. The guard training system of claim 15, wherein the training module is further operable determine and store one or more statistics based at least in part on the received answers.

18. The guard training system of claim 15, wherein the training module is operable to determine one or more training questions based at least in part on answers previously received from the communicator.

19. The guard training system of claim 15, wherein the communicator is further operable to transmit the collected data via the network to a monitoring center at a point in time proximate to the time at which the data is collected at each of the one or more tour points.

20. The guard training system of claim 19, wherein the communicator is further operable to transmit the collected data via the network to the monitoring center at a point in time proximate to the time at which the data is collected at each of the one or more tour points.
